(19) United States
(12) Patent Application Publication
(10) Pub. No.: US 2010/0144386 A1
(43) Pub. Date: Jun. 10, 2010

(54) PORTABLE ELECTRONIC DEVICE HAVING A ROTARY CAMERA UNIT

(75) Inventor: Cyrille Davoine, Le Mans (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/442,714

(22) PCT Filed: Sep. 25, 2007
(86) PCT No.: PCT/IB2007/053879

§ 371 Date: Mar. 25, 2009

(30) Foreign Application Priority Data
Sep. 27, 2006 (EP) 06300990.6

(51) Int. Cl. H04M 1/00; H04N 5/225

(52) U.S. Cl. 455/556.1; 348/374; 348/E05.024

(57) ABSTRACT

The present invention relates to a portable electronic device comprising: a housing; a camera unit (1), which can be rotated relative to the housing, for capturing an image;—electromechanical detection means for detecting a rotational position of the camera unit, wherein the electromechanical means comprise a cam (3) attached to the camera unit and a switch, said switch comprising two blades (4, 5) attached to the housing and surrounding the cam, the cam being adapted to hit one of the two blades when the camera unit is rotated so that the two blades are no longer in contact.

### FIELD OF THE INVENTION

This invention relates generally to a portable electronic device, such as a cordless or mobile phone, and, more particularly, to a portable electronic device comprising a rotary camera unit for capturing images and electromechanical detection means for detecting a rotational position of the camera unit.

### BACKGROUND OF THE INVENTION

US patent application US2005/0052526 discloses a portable electronic device, more especially a mobile communication terminal, said device comprising a housing, a rotary camera unit, which can be rotated relative to the housing, for capturing images and electromechanical detection means for detecting a rotational position of the camera unit. The electromechanical means comprise a protrusion which is rotated as a result of the rotation of the camera unit and a conventional switch electrically connected (namely soldered) to a printed circuit board PCB, said PCB being fixed to the device housing. As the camera unit is rotated, the protrusion is correspondingly rotated and depresses the switch upon contact, thus indicating that the camera unit has changed its orientation.

### SUMMARY OF THE INVENTION

It is an object of the invention to propose a portable electronic device comprising a rotary camera unit and electromechanical means for detecting the rotational position of the camera unit, which is more robust than the solution of the prior art.

To this end, the portable electronic device in accordance with the invention is characterized in that it comprises:

a housing;

a camera unit, which can be rotated relative to the housing, for capturing an image;

electromechanical detection means for detecting a rotational position of the camera unit, wherein the electromechanical means comprise a cam attached to the camera unit and a switch, said switch comprising two blades attached to the housing and surrounding the cam, the cam being adapted to hit one of the two blades when the camera unit is rotated so that the two blades are no longer in contact.

The electromechanical means of the prior art comprising a protrusion and a conventional switch have been replaced by dedicated electromechanical means comprising a cam and a switch comprising two blades surrounding the cam. Said dedicated electromechanical means are particularly robust, cost-effective and easy to implement since they are not sensitive to dust or other parasitic features and therefore do not require to be sealed. Furthermore the electromechanical means according to the invention provide a longer life cycle than conventional electromechanical means.

According to an exemplary embodiment of the invention, the portable electronic device further comprises image processing means for reorienting the image captured by the camera unit depending on the rotational position detected by the electromechanical means.

Beneficially, an electric current flows through the blades when the cam does not hit one of the blades indicating that the camera unit has a first rotational position and no electric current flows through the blades when the cam hits one of the blades indicating that the camera unit has a second rotational position.

According to another exemplary embodiment of the invention, the portable electronic device comprises further comprising a crown gear fixed to the camera unit and the cam, and a flexible plate fixed to the housing, the crown gear and the flexible plate being coupled to each other.

Still according to another exemplary embodiment of the invention, the portable electronic device further comprises a display, the camera unit comprises a camera lens, the electromechanical detection means are able to detect a predetermined rotational position of the camera unit where the display and the camera lens are on opposite sides of the housing, and the image processing means are adapted to reverse the image captured by the camera unit if said camera unit is in said predetermined rotational position.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawings, wherein:

FIG. 1 shows a portable electronic device according to an exemplary embodiment of the present invention;

FIG. 2 illustrates the use of the portable electronic device in a first operation mode;

FIG. 3 illustrates the use of the portable electronic device in a second operation mode;

FIG. 4 shows a perspective view of the arrangement comprising the camera unit and electromechanical means in accordance with the invention;

FIG. 5 shows an exploded view of the arrangement comprising the camera unit and electromechanical means in accordance with the invention;

FIG. 6 shows a cross-section view of the arrangement comprising the camera unit and electromechanical means in accordance with the invention when the two blades are in contact; and

FIG. 7 shows a cross-section view of the arrangement comprising the camera unit and electromechanical means in accordance with the invention when the two blades are no longer contact.

### DETAILED DESCRIPTION OF THE INVENTION

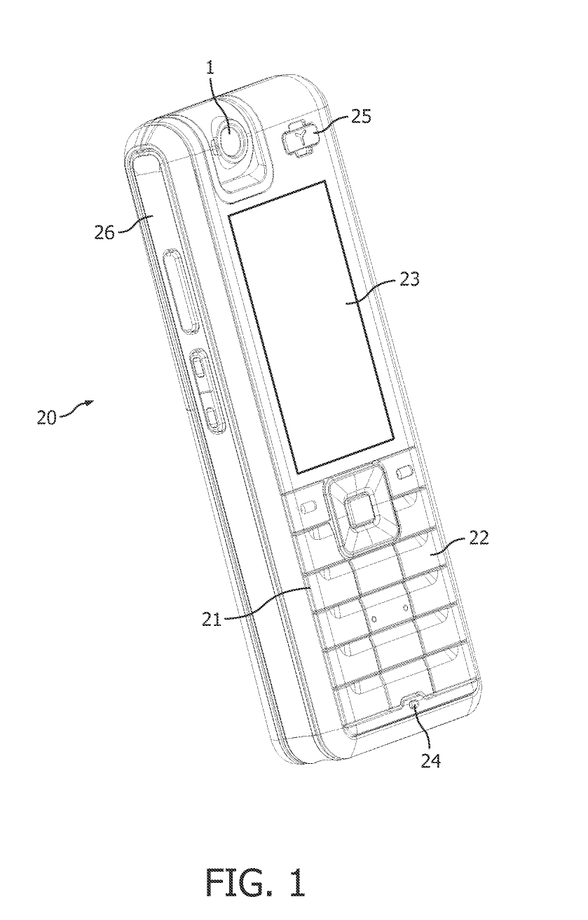

Referring to FIG. 1 of the drawings, a portable electronic device 20 according to an exemplary embodiment of the present invention is depicted. This portable electronic device is either a cordless phone or a mobile phone. It may also be a personal digital assistant (PDA) or even a camera. The portable electronic device comprises a housing 26 including a key entry section 21 that comprises a number of button switches 22 for dial entry and other functions. A display unit 23 is disposed above the key entry section 21. A microphone 24 and an earpiece 25, located at opposite ends of the portable electronic device 20, are provided for receiving audio signals from the surrounding area and transmitting audio signal coming from the telecommunications network.

A camera unit 1, the outer lens of which is visible, is incorporated into the portable electronic device 20, above the display unit 23. This camera unit is capable of capturing a first picture showing information about the callee, for example his face. This camera unit is also capable of capturing a second picture showing information about the caller, for example his face, so that the caller can control the information he sends to the callee. The display unit 23 may comprise two different frames, a first frame of great size showing the first picture and a second frame having a reduced size and showing the second picture.

In order to achieve such a video transmission/reception, the portable electronic device 20 comprises audio and video codecs, i.e. encoders and decoders (not represented). As an example, the video codec is based on the MPEG4 or the H.263 video encoding/decoding standard. Similarly, the audio codec is based, for example, on the MPEG-AAC or G.729 audio encoding/decoding standard.

The camera unit 1 is mounted rotative relative to the housing 26 of the portable electronic device 20.

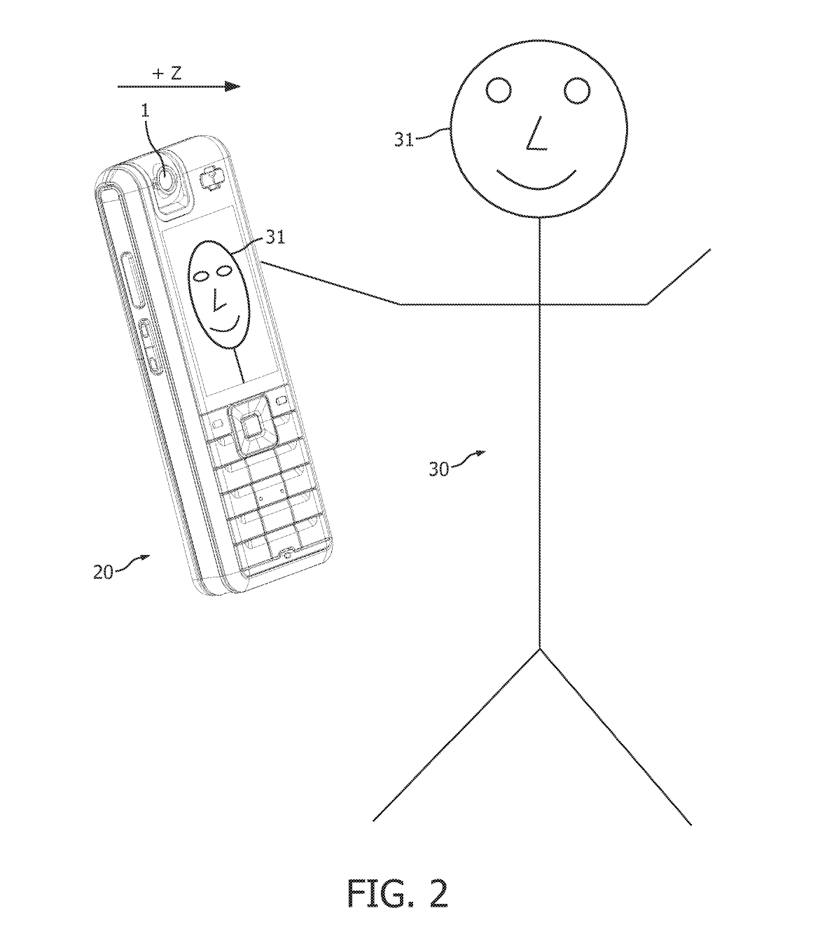

According to a first position of the camera unit 1 shown in FIG. 2, where the camera lens is on the same side of the housing as the display unit 23 (i.e. the camera lens is orientated in the +Z direction), the camera unit is able to capture a picture showing for example the face 31 of the callee 30. This capture mode is also referred to as self-portrait mode. The portable electronic device 20 is then able to display the captured picture.

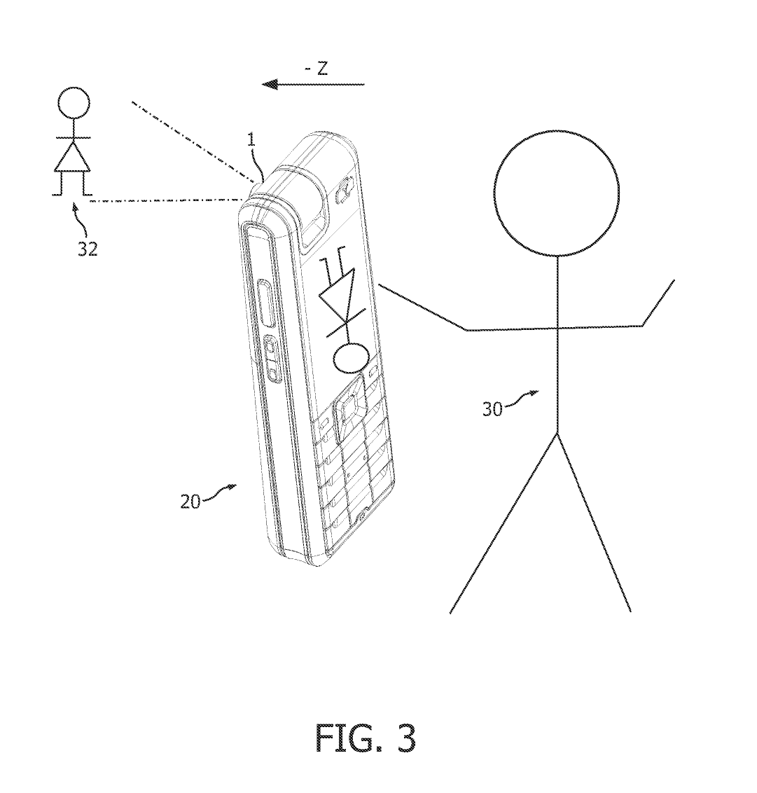

According to a second position of the camera unit 1 shown in FIG. 3, where the camera lens is on a side of the housing opposite to the side of the display unit 23 (i.e. the camera lens is orientated in the −Z direction), said camera unit is able to capture a picture showing a third party 32 in the vicinity of the callee 30. This capture mode is also referred to as camcorder mode. The portable electronic device is then able to display the captured picture. As shown in FIG. 3, if no image processing is performed on the captured image, said image of the third party 32 is reversed on the display unit, i.e. the person is displayed from bottom to top instead of top to bottom, which does not correspond to reality. That is why the portable electronic device in accordance with the invention comprises conventional image processing means (not represented) for reversing the picture so that a picture in accordance with reality is displayed. Such image processing means are adapted to reverse the captured image depending on the position of the camera unit, namely when the camera lens is orientated in the −Z direction. To this end, the portable electronic device in accordance with the invention comprises detection means for detecting the position of the camera unit.

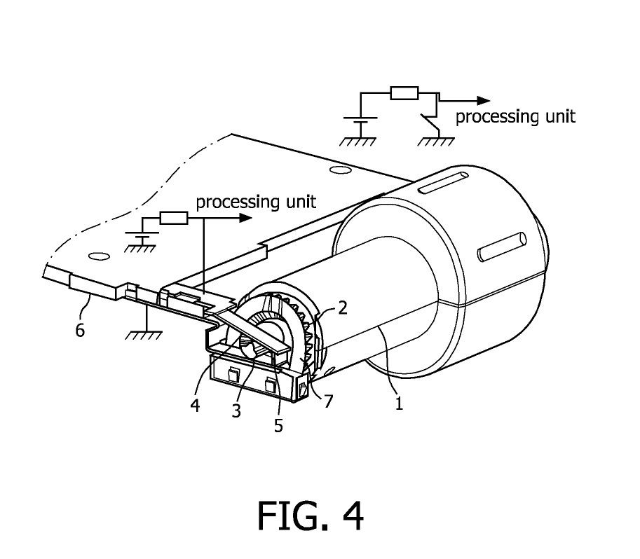

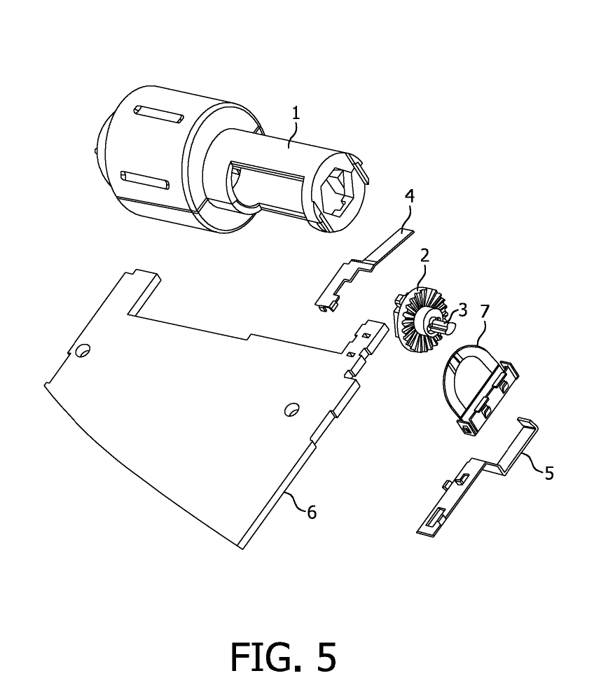

Referring to FIG. 4 (perspective view) and FIG. 5 (exploded view), the electromechanical detection means are described in more detail.

The electromechanical means comprise:

a crown gear 2;

a cam 3 attached to the crown gear 2. In an exemplary embodiment, the crown gear 2 and the cam 3 define a single part that is attached to the rotary camera unit 1. This single part, made with non-electrical conductive material rotates at the same time as the camera unit rotates.

a switch attached to the housing via the printed circuit board 6. The switch comprises two blades 4 and 5 surrounding the cam 3.

Beneficially, the material constituting the two blades is electrically conductive to allow the flowing of an electric current. In this case, the two blades are soldered to the printed circuit board 6 attached itself to the housing.

The camera unit may be rotated manually. To this end, the crown gear 2 fixed to the camera unit 1 is coupled to a flexible plate 7 fixed to the housing. The coupling of the crown gear 2 and the flexible plate 7 is such that, when the camera unit rotates, the gear teeth of the crown gear 2 press against the flexible plate 7, and when the rotation is stopped, the flexible plate 7 rests between two gear teeth. The position and number of gear teeth depend on the elementary rotation to be achieved. As an example, the gear teeth are dimensioned so as to achieve a rotation of 15 degrees per gear tooth and the crown gear 2 comprises 14 gear teeth so as to achieve a maximum rotation of 210 degrees.

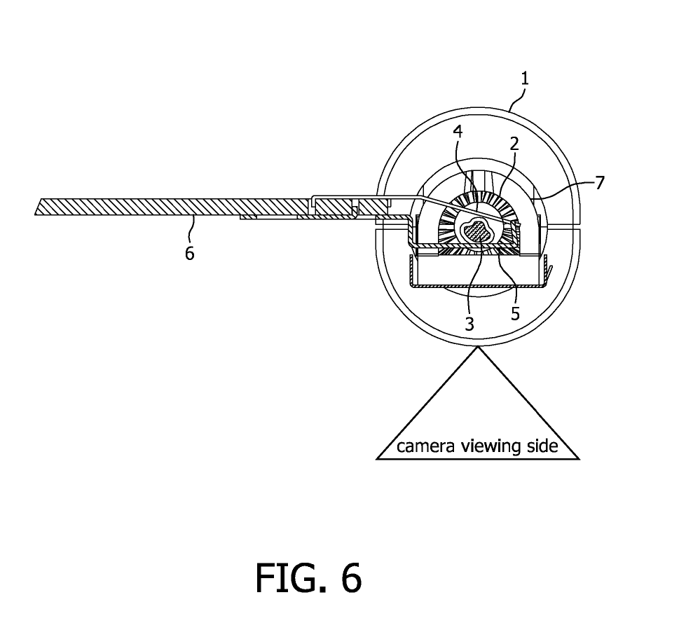

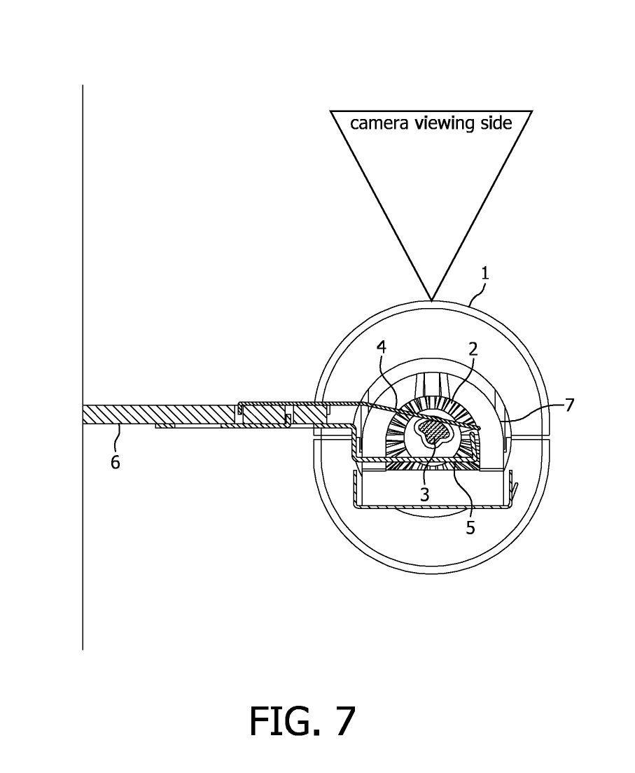

FIG. 6 and FIG. 7 illustrate the operation of the electromechanical detection means in order to detect the rotational position of the camera unit.

According to a first configuration shown in FIG. 6, the two blades 4 and 5 are in contact with each other when the cam does not hit one of them. This position of the blades corresponds to a first rotation state of the camera unit 1. For this state, the electric circuit is closed and an electrical current can flow through the two blades. In this example, the rotation position of the camera unit is such that the processing unit is adapted to reverse the picture captured by the camera unit.

According to a second configuration shown in FIG. 7, the cam 3 hits one of the two blades 4 when the camera is rotated and therefore the two blades are no longer in contact. This position of the blades corresponds to a second rotation state of the camera unit 1. For this state, the electric circuit is open and no electrical current can flow through the two blades. In this example, the rotation position of the camera unit is such that the processing unit does not need reverse the picture captured by the camera unit.

The operation of the electromechanical detection means has been depicted in the context of FIGS. 6 and 7 but it will be apparent to a skilled person that the invention is not restricted to this particular position of the camera. As a matter of fact, the invention is not limited by the number of available camera mode which can be more than two. In this case, the electromechanical means may comprise more than one switch or a switch comprising more than one pair of blades, and more than one cam or a cam with a suitable shape. The invention is also not limited by the processing function implemented by the image processing means which can be other geometric transformations, for example rotation or translation, than the reversing function.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A portable electronic device (20) comprising:
a housing (26);
a camera unit (1), which can be rotated relative to the housing, for capturing an image;
electromechanical detection means for detecting a rotational position of the camera unit, wherein the electromechanical means comprise a cam (3) attached to the camera unit and a switch, said switch comprising two blades (4,5) attached to the housing and surrounding the cam, the cam being adapted to hit one of the two blades when the camera unit is rotated so that the two blades are no longer in contact.

2. A portable electronic device as claimed in claim 1, further comprising image processing means for reorienting the image captured by the camera unit depending on the rotational position detected by the electromechanical means.

3. A portable electronic device as claimed in claim 1, wherein an electric current flows through the blades when the cam does not hit one of the blades indicating that the camera unit has a first rotational position and wherein no electric current flows through the blades when the cam hits one of the blades indicating that the camera unit has a second rotational position.

4. A portable electronic device as claimed in claim 1, further comprising a crown gear (2) fixed to the camera unit (1) and the cam (3), and a flexible plate (7) fixed to the housing, the crown gear (2) and the flexible plate (7) being coupled to each other.

5. A portable electronic device (20) as claimed in claim 1, further comprising a display (23), wherein the camera unit (1) comprises a camera lens, wherein the electromechanical detection means are able to detect a predetermined rotational position of the camera unit where the display and the camera lens are on opposite sides of the housing (26), and wherein the image processing means are adapted to reverse the image captured by the camera unit if said camera unit is in said predetermined rotational position.

6. A portable electronic device as claimed in claim 1, wherein the device is a cordless phone.

7. A portable electronic device as claimed in claim 1, wherein the device is a mobile phone.
